(19) United States
(12) Patent Application Publication
(10) Pub. No.: US 2011/0219200 A1
(43) Pub. Date: Sep. 8, 2011

(54) SYSTEM AND METHOD TO ARCHIVE EMAIL MESSAGES IN A SOFTWARE AS A SERVICE SYSTEM

(75) Inventor: Lei Xiao, Beijing (CN)

(73) Assignee: Computer Associates Think, Inc., Islandia, NY (US)

(21) Appl. No.: 12/717,241

(22) Filed: Mar. 4, 2010

(51) Int. Cl. G06F 12/16; G06F 15/16

(52) U.S. Cl. 711/161; 709/206; 711/E12.103

(57) ABSTRACT

A system includes a client machine or first server, and a second server. The first server is coupled via a network connection to the second server. The second server is configured to provide an electronic mail service. The first server includes a processor configured to receive an electronic mail message from the second server via a network browser rendered on the client machine, to apply an archive policy to the electronic mail message, and to store the electronic mail message in a computer data storage medium coupled to the first server.

### FIELD OF THE INVENTION

The present disclosure relates to electronic mail systems offered as software as a service, and in an embodiment, but not by way of limitation, a system and method to archive electronic mail messages in an electronic mail system that is offered on a software as a service basis.

### BACKGROUND

It is typical for an electronic mail system to archive electronic mail messages within its system. In a conventional electronic mail system, in which a client machine is coupled to an email server, a traditional archive method can be employed. For example, an application program interface (API) such as Messaging Application Programming Interface (MAPI) or Log Shipping connects to the email server and retrieves a message. The message is then captured from a gateway server (Simple Mail Transfer Protocol (SMTP) gateway), and to archive the email message, the email message is sent to a special mailbox or SMTP host (e.g., Envelop Journaling).

The approaches described in this background section could be pursued, but are not necessarily approaches that have been previously conceived or pursued. Therefore, unless otherwise indicated herein, the approaches described in this background section are not prior art to the claims in this application and are not admitted to be prior art by inclusion in this background section.

### Summary

A system includes a first server and a second server. The first server is coupled via a network connection to the second server. The second server is configured to provide an electronic mail service. The first server includes a processor configured to receive an electronic mail message from the second server via a browser rendered on a client interface device that is coupled to the first server. The first server processor is further configured to apply an archive policy to the electronic mail message, and to store the electronic mail message in a computer data storage medium coupled to the first server.

### BRIEF DESCRIPTION OF THE DRAWINGS

FIG. 1 is a system diagram of an example embodiment of an archive system in a Software as a Service (SaaS) electronic mail system.

FIG. 2 is a flowchart of an example embodiment of a process to archive email messages in a software as a service based electronic mail system.

FIG. 3 is a flowchart of another example embodiment of a process to archive email messages in a software as a service based electronic mail system.

FIG. 4 is a system and functionality diagram of an example embodiment of a software as a service electronic mail system.

FIG. 5 is an example embodiment of a computer system upon which one or more embodiments of the present disclosure can operate.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Embodiments of the invention include features, methods or processes embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)). Consequently, a machine-readable medium can be either tangible or intangible in nature.

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include digital/analog signal processing systems, software, data processing hardware, data processing system-implemented methods, and various processing operations, further described herein.

A number of figures show block diagrams of systems and apparatus of embodiments of the invention. A number of figures show flow diagrams illustrating systems and apparatus for such embodiments. The operations of the flow diagrams will be described with references to the systems/apparatuses shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

It has been predicted that by the end of the year 2012 twenty per cent of the commercial electronic mail market will be using a software as a service (SaaS) platform. This raises an issue of how to go about archiving messages in an SaaS email system. While it could be done in the traditional way explained above, in practice such a method in an SaaS email system is too complex. A reason for such complexity is that in an SaaS email system, the email server is located on the Internet, and it would occupy a huge amount of network resources to archive email messages in an email SaaS system via the above-explained traditional method. Additionally, an email customer may have limited authority within an SaaS model (because the deployment was provided by a third party company), thereby adding further complexity to an archive process in such an SaaS platform. Consequently, the art would benefit from an improved system and method to archive electronic mail messages in an SaaS-based electronic mail system.

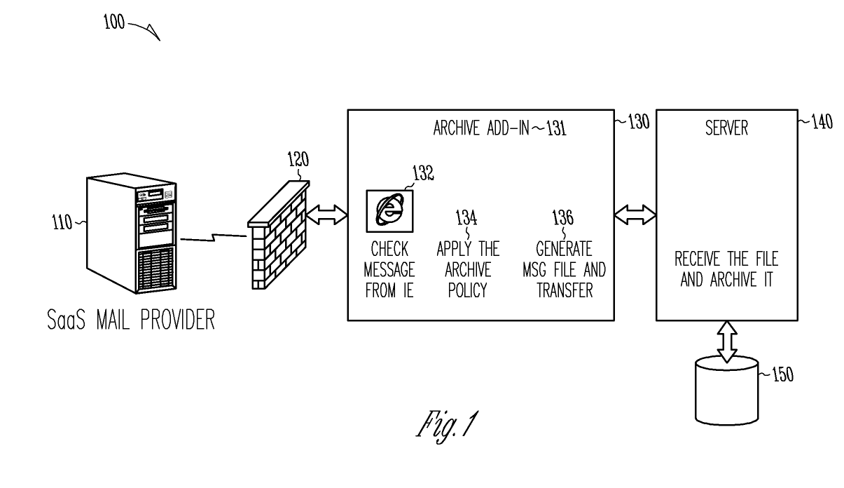

FIG. 1 is a system diagram of an example embodiment of an archive system 100 in a Software as a Service (SaaS) electronic mail system. The system 100 includes a Software as a Service (SaaS) mail provider 110. A client machine 130 connects to the SaaS mail provider 110 via a network such as the Internet. The client machine 130 can include a firewall 120. In an embodiment, the client machine includes an Archive Add-in 131. A purpose of the Archive Add-in 131 is to provide a functionality of archiving a user's electronic mail messages in an SaaS email system. The Archive Add-in 131 can include a processor or module 132 to check messages from a web browser such as Internet Explorer, a processor or module 134 to apply the archive policy, and a processor or module 136 to generate a message file and transfer the message file to a server and/or database for storage. The message file is a file that contains the electronic mail messages that are to be archived. The client machine 130 is coupled to a server 140 that receives and archives the messages in a computer storage medium 150.

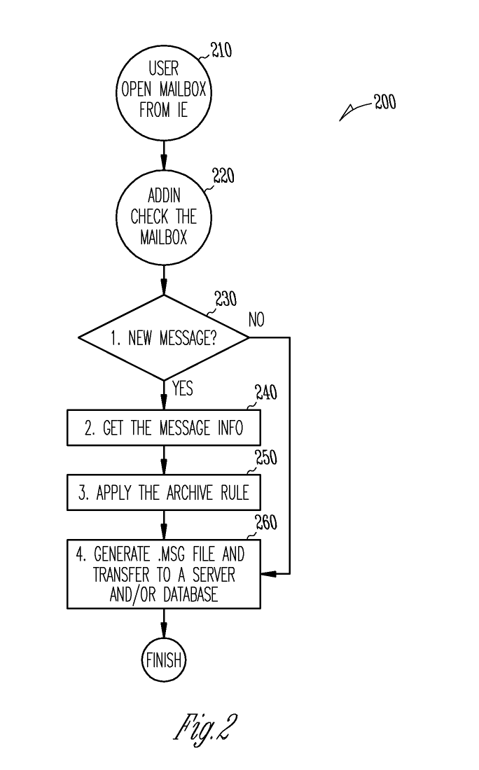

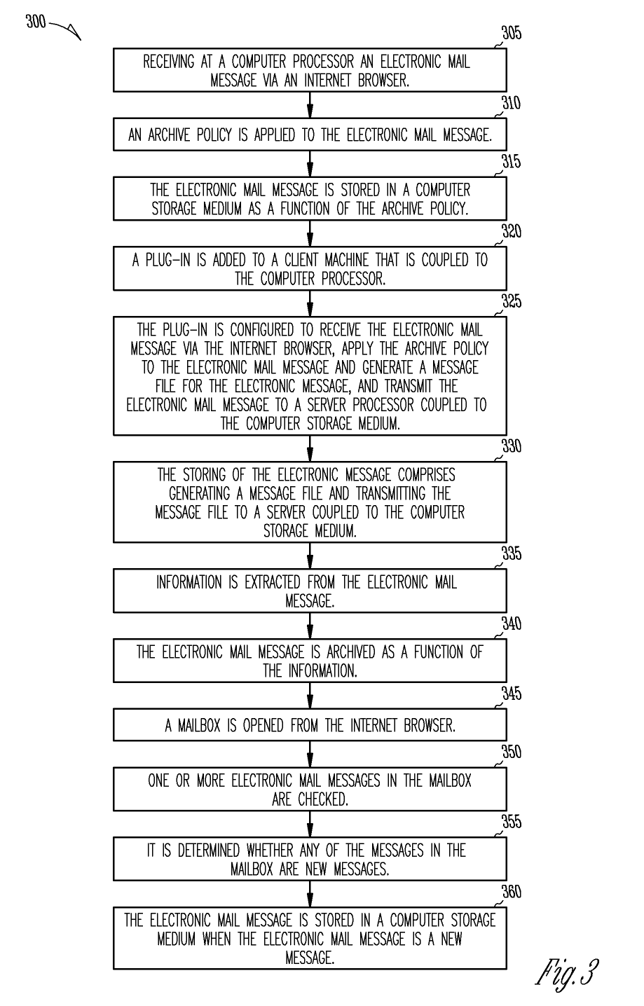

FIGS. 2 and 3 are flowcharts of example processes 200 and 300 for archiving electronic mail messages in an SaaS electronic mail system. FIG. 2 includes a number of process blocks 210-260, and FIG. 3 includes a number of process blocks 305-360. Though arranged serially in the examples of FIGS. 2 and 3, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring first to FIG. 2, in the process 200 a user opens his or her electronic mailbox at 210 using an Internet browser such as Internet Explorer. At 220, the Archive Add-in 131 (FIG. 1) checks the user's inbox, and in particular, at 230, the Archive Add-in 131 checks the user's inbox for new messages. If there are no new messages in the user's inbox, the process 200 proceeds to block 260. If there are new messages, the Archive Add-in 131 retrieves the message information for each new message at 240, and applies the archive rule at 250. The archive rule at 250 can include any rules regarding the archiving of email messages such as only new messages are archived, only messages of a certain age are archived, only messages in a user's inbox are archived (and not messages in a user's deleted box), and only non-spam messages are archived. At 260, a message file containing new messages is generated, and then transferred to a server 140 for storage in a database 150.

Referring to FIG. 3, the process 300 at 305 receives at a computer processor an electronic mail message via an Internet browser. At 310, an archive policy is applied to the electronic mail message, and at 315, the electronic mail message is stored in a computer storage medium as a function of the archive policy. As noted above, the archive policy can include one or more rules to determine the archive procedures.

At 320, a plug-in is added to a client machine that is coupled to the computer processor. As noted at 325, the plug-in is configured to receive the electronic mail message via the Internet browser, apply the archive policy to the electronic mail message, generate a message file for the electronic message, and transmit the electronic mail message to a server processor coupled to the computer storage medium. At 330, the storing of the electronic mail message comprises generating a message file and transmitting the message file to a server coupled to the computer storage medium. At 335, information is extracted from the electronic mail message, and at 340, the electronic mail message is archived as a function of the information. At 345, a mailbox is opened from the Internet browser. One or more electronic mail messages in the mailbox are checked at 350, and at 355 it is determined whether any of the messages in the mailbox are new messages. At 360, the electronic mail message is stored in a computer storage medium when the electronic mail message is a new message.

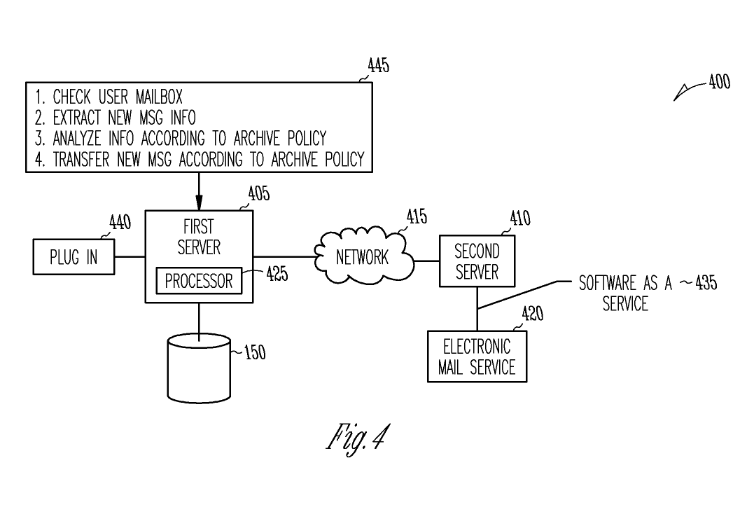

FIG. 4 is a system and functionality diagram of an example embodiment of an SaaS electronic mail system. The system 400 in FIG. 4 includes a first server 405 and a second server 410. The first server 405 and the second server 410 are coupled to each other via a network 415. The second server 410 is configured to provide an electronic mail service 420. The first server 405 includes a processor 425 that is configured to receive an electronic mail message from the second server 410 via an Internet browser that is rendered on a client interface device coupled to the first server 405. The processor 425 is further configured to apply an archive policy to the electronic mail message. As noted above, the archive policy can include several rules to determine which messages are archived. The processor 425 is further configured to store the electronic mail message in a computer data storage medium 150 that is coupled to the first server 405.

As noted at 435, the electronic mail service provided by the second server 410 is provided as Software as a Service (SaaS). Further as noted at 440, the first server 405 can be configured to receive a plug-in, and the plug can be configured to apply the archive policy and store the electronic mail message in the computer data storage medium. At 445, the first server 405 is configured to check a user's mailbox upon logon to the mailbox by the user, extract information from a new message in the mailbox, analyze the information according to the archive policy, and transfer the new message to the computer data storage medium when the new message meets the conditions of the archive policy.

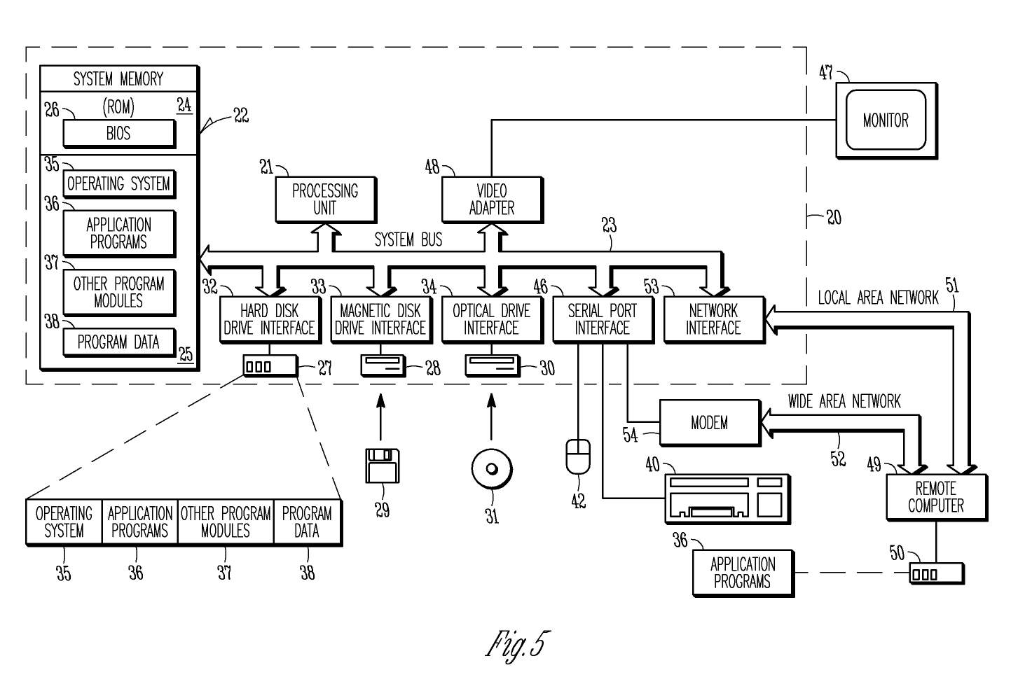

FIG. 5 is an overview diagram of a hardware and operating environment in conjunction with which embodiments of the invention may be practiced. The description of FIG. 5 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 5, a hardware and operating environment is provided that is applicable to any of the servers and/or remote clients shown in the other Figures.

As shown in FIG. 5, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/0 relative to the computer 20, although only a memory storage device 50 has been illustrated. The logical connections depicted in FIG. 5 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

### EXAMPLE EMBODIMENTS

In Example 1, a system comprises a first server coupled via a network connection to a second server, the second server configured to provide an electronic mail service; wherein the first server comprises a processor configured to receive an electronic mail message from the second server via a browser rendered on a client interface device coupled to the first server, to apply an archive policy to the electronic mail message, and to store the electronic mail message in a computer data storage medium coupled to the first server.

In Example 2, a system optionally includes the features of Example 1, and further optionally includes a feature of the second server.

In Example 3, a system optionally includes any features of Examples 1-2, and further optionally includes a feature of the computer data storage medium.

In Example 4, a system optionally includes any features of Examples 1-3, and further optionally includes a feature of the client interface device.

In Example 5, a system optionally includes any features of Examples 1-3, and further optionally includes a feature of wherein the electronic mail service provided by the second server is provided as software as a service.

In Example 6, a system optionally includes any features of Examples 1-5, and further optionally includes a feature of wherein the first server processor configured to receive an electronic mail message is configured to receive a plug-in, the plug configured to apply the archive policy and store the electronic mail message in the computer data storage medium.

In Example 7, a system optionally includes any features of Examples 1-6, and further optionally includes a feature of wherein the first server processor is configured to check a user's mailbox upon logon to the mailbox by the user, extract information from a new message in the mailbox, analyze the information according to the archive policy, and transfer the new message to the computer data storage medium when the new message meets the conditions of the archive policy.

In Example 8, a system optionally includes any features of Examples 1-7, and further optionally includes a feature of wherein the network comprises the Internet.

In Example 9, a computerized process comprises receiving at a computer processor an electronic mail message via a network browser, applying an archive policy to the electronic mail message, and storing the electronic mail message in a computer storage medium as a function of the archive policy.

In Example 10, a computerized process optionally includes any features of Example 9, and further optionally includes a feature of adding a plug-in to a client machine coupled to the computer processor, wherein the plug-in is configured to receive the electronic mail message via the network browser, apply the archive policy to the electronic mail message, and generate a message file for the electronic message, and transmit the electronic mail message to a server processor coupled to the computer storage medium.

In Example 11, a computerized process optionally includes any features of Examples 9-10, and further optionally includes a feature of wherein the storing the electronic mail message comprises generating a message file and transmitting the message file to a server coupled to the computer storage medium.

In Example 12, a computerized process optionally includes any features of Examples 9-11, and further optionally includes a feature of extracting information from the electronic mail message; and archiving the electronic mail message as a function of the information.

In Example 13, a computerized process optionally includes any features of Examples 9-12, and further optionally includes a feature of opening a mailbox from the network browser; checking one or more electronic mail messages in the mailbox; determining if a message in the mailbox is a new message; and storing the electronic mail message in a computer storage medium when the electronic mail message is a new message.

In Example 14, a computerized process optionally includes any features of Examples 9-13, and further optionally includes a feature of wherein the electronic mail message is provided from a software as a service electronic mail system.

In Example 15, a tangible machine-readable medium includes that features of receiving at a computer processor an electronic mail message via a network browser, applying an archive policy to the electronic mail message, and storing the electronic mail message in a computer storage medium as a function of the archive policy.

In Example 16, a tangible machine-readable medium includes the features of Example 15, and further optionally includes a feature of instructions to perform a process comprising adding a plug-in to a client machine coupled to the computer processor, wherein the plug-in is configured to receive the electronic mail message via the network browser, apply the archive policy to the electronic mail message, generate a message file for the electronic message, and transmit the electronic mail message to a server processor coupled to the computer storage medium.

In Example 17, a tangible machine-readable medium optionally includes any features of Examples 15-16, and further optionally includes a feature of wherein the storing the electronic mail message comprises generating a message file and transmitting the message file to a server coupled to the computer storage medium.

In Example 18, a tangible machine readable medium optionally includes any features of Examples 15-17, and further optionally includes a feature of instructions to perform a process comprising extracting information from the electronic mail message; and archiving the electronic mail message as a function of the information.

In Example 19, a tangible machine-readable medium optionally includes any features of Examples 15-18, and further optionally includes a feature of opening a mailbox from the network browser; checking one or more electronic mail messages in the mailbox; determining if a message in the mailbox is a new message; and storing the electronic mail message in a computer storage medium when the electronic mail message is a new message.

In Example 20, a tangible machine-readable medium optionally includes any features of Examples 15-19, and further optionally includes a feature of wherein the electronic mail message is provided from a software as a service electronic mail system.

In Example 21, a system comprises a client machine coupled via a network connection to a server, the server configured to provide an electronic mail service; wherein the client machine comprises a processor configured to receive an electronic mail message from the server via a browser rendered on the client machine, to apply an archive policy to the electronic mail message, and to store the electronic mail message in a computer data storage medium coupled to the client machine.

Thus, an example system, method and machine readable medium for archiving electronic mail messages in an SaaS-based system has been described. Although specific example embodiments have been described, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
a first server coupled via a network connection to a second server, the second server configured to provide an electronic mail service;
wherein the first server comprises a processor configured to receive an electronic mail message from the second server via a browser rendered on a client interface device coupled to the first server, to apply an archive policy to the electronic mail message, and to store the electronic mail message in a computer data storage medium coupled to the first server.

2. The system of claim 1, further comprising the second server.

3. The system of claim 1, further comprising the computer data storage medium.

4. The system of claim 1, further comprising the client interface device.

5. The system of claim 1, wherein the electronic mail service provided by the second server is provided as software as a service.

6. The system of claim 1, wherein the first server processor configured to receive an electronic mail message is configured to receive a plug-in, the plug configured to apply the archive policy and store the electronic mail message in the computer data storage medium.

7. The system of claim 1, wherein the first server processor is configured to:
check a user's mailbox upon logon to the mailbox by the user;
extract information from a new message in the mailbox;
analyze the information according to the archive policy; and
transfer the new message to the computer data storage medium when the new message meets the conditions of the archive policy.

8. The system of claim 1, wherein the network comprises the Internet.

9. A computerized process comprising:
receiving at a computer processor an electronic mail message via a network browser;
applying an archive policy to the electronic mail message; and
storing the electronic mail message in a computer storage medium as a function of the archive policy.

10. The computerized process of claim 9, comprising adding a plug-in to a client machine coupled to the computer processor, wherein the plug-in is configured to receive the electronic mail message via the network browser, apply the archive policy to the electronic mail message, and generate a message file for the electronic message, and transmit the electronic mail message to a server processor coupled to the computer storage medium.

11. The computerized process of claim 9, wherein the storing the electronic mail message comprises generating a message file and transmitting the message file to a server coupled to the computer storage medium.

12. The computerized process of claim 9, comprising extracting information from the electronic mail message; and archiving the electronic mail message as a function of the information.

13. The computerized process of claim 9, comprising opening a mailbox from the network browser; checking one or more electronic mail messages in the mailbox; determining if a message in the mailbox is a new message; and storing the electronic mail message in a computer storage medium when the electronic mail message is a new message.

14. The computerized process of claim 9, wherein the electronic mail message is provided from a software as a service electronic mail system.

15. A tangible machine-readable medium storing instructions, which, when executed by a processor, cause the processor to perform a process comprising:
receiving at a computer processor an electronic mail message via a network browser;
applying an archive policy to the electronic mail message; and
storing the electronic mail message in a computer storage medium as a function of the archive policy.

16. The tangible machine readable medium of claim 15, comprising instructions to perform a process comprising adding a plug-in to a client machine coupled to the computer processor, wherein the plug-in is configured to receive the electronic mail message via the network browser, apply the archive policy to the electronic mail message, and generate a message file for the electronic message, and transmit the electronic mail message to a server processor coupled to the computer storage medium.

17. The tangible machine readable medium of claim 15, wherein the storing the electronic mail message comprises generating a message file and transmitting the message file to a server coupled to the computer storage medium.

18. The tangible machine readable medium of claim 15, comprising instructions to perform a process comprising extracting information from the electronic mail message; and archiving the electronic mail message as a function of the information.

19. The tangible machine readable medium of claim 15, comprising opening a mailbox from the network browser; checking one or more electronic mail messages in the mailbox; determining if a message in the mailbox is a new message; and
storing the electronic mail message in a computer storage medium when the electronic mail message is a new message.

20. The tangible machine readable medium of claim 15, wherein the electronic mail message is provided from a software as a service electronic mail system.

21. A system comprising:
a client machine coupled via a network connection to a server, the server configured to provide an electronic mail service;
wherein the client machine comprises a processor configured to receive an electronic mail message from the server via a browser rendered on the client machine, to apply an archive policy to the electronic mail message, and to store the electronic mail message in a computer data storage medium coupled to the client machine.
